(19) United States
(12) Patent Application Publication
(10) Pub. No.: US 2017/0096906 A1
(43) Pub. Date: Apr. 6, 2017

(54) SEALING FIN ARMORING AND METHOD FOR THE PRODUCTION THEREOF

(71) Applicant: MTU Aero Engines AG, Munich (DE)

(72) Inventors: André WERNER, Lichtenstein/Sa. (DE); Manuel PUSCH, Weltenburg (DE); Philipp UTZ, Munich (DE); Heinrich WALTER, Friedberg (DE)

(21) Appl. No.: 15/204,181

(22) Filed: Jul. 7, 2016

(30) Foreign Application Priority Data
Jul. 20, 2015 (DE) 102015213555.1

(51) Int. Cl. F01D 11/08; C23C 4/134; C23C 24/04; F04D 29/38; F01D 5/14; F04D 29/08; F04D 29/32; C23C 4/129; C23C 4/131

(52) U.S. Cl. CPC F01D 11/08; C23C 4/129; C23C 4/134; C23C 24/04; C23C 4/131; F01D 5/147; F04D 29/083; F04D 29/324; F04D 29/388; F05D 2220/323; F05D 2230/90; F05D 2240/307; F05D 2300/177; F05D 2230/312; F05D 2230/311; F05D 2300/2112; F05D 2300/2118; F05D 2300/2282; F05D 2300/2262; F05D 2300/2263

(57) ABSTRACT

A method for coating a sealing fin (2) on a component of a turbomachine, in particular on a blade tip (6) of a blade (1) of a turbomachine, with armoring (3, 30, 300), and to a corresponding component, in which method a blade (1) having at least one sealing fin (2) and a slurry which comprises particles of MCrAlY or particles for forming an MCrAlY layer (31), where M is nickel and/or cobalt, are provided, the slurry is applied onto the sealing fin and dried, and the sealing fin with the applied slurry is subjected to an aluminizing process so that the MCrAlY layer comprises an Al-rich sublayer (32).

### CROSS-REFERENCE TO RELATED APPLICATIONS

The present application claims priority under 35 U.S.C. §119 of German Patent Application No. 102015213555.1, filed Jul. 20, 2015, the entire disclosure of which is expressly incorporated by reference herein.

### BACKGROUND OF THE INVENTION

1. Field of the Invention

The present invention relates to a method for coating at least one sealing fin of a component of a turbomachine, and in particular of a blade tip of a blade of a turbomachine, with armoring. The present invention furthermore relates to a component, and in particular a blade of a turbomachine, having at least one, and preferably a plurality of sealing fins on the blade tip, comprising armoring on the sealing fin or fins, the armoring comprising an MCrAlY layer, where M is nickel and/or cobalt.

2. Discussion of Background Information

In turbomachines, such as static gas turbines or aircraft engines, fluid such as air or combustion gases flows through a flow channel, the fluid interacting, on its way through the flow channel, with guide vanes and rotor blades which are arranged in the flow channel. While the guide vanes are installed in a fixed fashion, the rotor blades are arranged on a rotatable shaft so that they execute a rotational movement with the shaft during operation of the turbomachine.

In order to ensure efficient interaction of the flowing fluid with the rotor blades and the guide vanes of the turbomachine, it is necessary that the fluid cannot flow past through gaps between a rotor blade and a surrounding housing, or the guide vanes and the rotating shaft of the turbomachine. Accordingly, the gaps between rotor blades and the surrounding housing and between guide vanes and the rotating shaft should be kept as small as possible. However, variations in relation to the gap width occur because of various ambient parameters and different operating conditions, so that for effective sealing between the rotor blades and the enclosing housing, or the guide vanes and the rotating shaft, so-called labyrinth seals or running-in coatings have been developed, which make it possible for the rotating parts to bed into the seal or the running-in coating on the stationary components with a reducing gap width, so as to generate a seal which is as good as possible between the moving component and the stationary component.

For example, it is known from EP 2 604 797 A1, the entire disclosure of which is incorporated by reference herein, to provide rotor blades having sealing fins arranged on the rotor blade tip with an abrasive coating on the sealing fins, in order to protect the sealing fins from wear when bedding in. To this end, EP 2 604 797 A1 proposes to protect the sealing fins of the rotor blades by means of a sprayed-on coating, the coating widening axially outward in the radial direction of the rotor blade, or the sealing fins The axial direction is in this case given by the rotation axis or longitudinal axis of the turbomachine, and the radial direction extends perpendicularly outward therefrom.

Although good results in terms of the wear resistance have already been achieved, one problem is that such rotor blades need to be operated at higher operating temperatures in order to increase the efficiency, so that greater oxidation resistance is necessary.

Although it is known from EP 2 796 588 A1, the entire disclosure of which is incorporated by reference herein, to provide high-temperature protection coatings of an MCrAlY alloy for rotor blades, where M may be formed by iron, cobalt or nickel or combinations thereof, such layers nevertheless do not have a sufficient wear resistance.

Correspondingly, such MCrAlY layers are modified with hard material particles as wear protection layers, in which the hard material particles are embedded in an MCrAlY matrix, as is described in the documents EP 1 042 541 B1, DE 10 2005 038 374 A1 and EP 0 686 229 B1, the entire disclosures of which are incorporated by reference herein. En order to produce such layers having embedded hard material particles, electrolytic deposition methods are conventionally used in order to deposit at least the matrix around the hard material particles. Such methods, however, are difficult to carry out for the coating of outwardly protruding sealing fins on blade tips.

In view of the foregoing, it would be advantageous to have available a method for coating a sealing fin on a component on a turbomachine, and a corresponding component of a turbomachine having an armored sealing fin, in which case it should be possible to carry out the production or the method simply and reliably and the armored sealing fin should have a sufficient wear resistance together with a high oxidation resistance.

### SUMMARY OF THE INVENTION

The present invention provides a method for coating a sealing fin on a component of a turbomachine with armoring, in which method a blade having at least one sealing fin is provided. The method comprises applying onto the sealing fin a slurry that comprises particles of MCrAlY or particles for forming an MCrAlY layer, where M represents nickel and/or cobalt, and aluminizing the sealing fin having the slurry applied thereon.

In one aspect of the method, the sealing fin on the blade tip of a blade of a turbomachine may be coated.

In another aspect, the slurry may comprise hard material particles.

In yet another aspect of the method, the method may further comprise the deposition of a hard material layer on the coating following the aluminizing For example, depositing the hard material layer may be carried out by one or more of spraying, thermal spraying, flame spraying, high-velocity flame spraying, electric arc spraying, cold gas spraying, detonation spraying, laser spraying, and plasma spraying and/or the hard material layer may be formed from aluminum oxide and/or titanium oxide.

In yet another aspect, the hard material particles may comprise at least one substance selected from oxides, carbides, nitrides, for example, one or more of boron nitride, cubic boron nitride, aluminum oxide, titanium oxide, titanium carbide, tungsten carbide, chromium carbide, zirconium oxide.

In a still further aspect, the method may further comprise drying the slurry before aluminizing and/or carrying out the aluminizing with an activator which contains halogen. For example, the slurry may be dried at a temperature of from about 100° C. to 200° C., e.g., from about 120° C. to 150° C.

In another aspect, the particles of MCrAlY or particles for forming an MCrAlY layer may have a particle size of from about 1 μm to 200 μm, e.g., of from about 5 μm to 120 μm.

The present invention further provides a component of a turbomachine. The component comprises at least one sealing fin on a blade tip of a blade. The at least one sealing fin comprises armoring which comprises an MCrAlY layer, where M represents nickel and/or cobalt. Further, a hard material layer is present on the MCrAlY layer and an Al-rich layer is present in an interface region between the MCrAlY layer and the hard material layer.

In one aspect of the component, the blade may comprises a plurality of sealing fins on the at least one blade tip.

In another aspect, the hard material layer may be formed from aluminum oxide and/or titanium oxide.

On the basis of EP 2 604 797 A1, instead of spray coating of the sealing fins, the invention proposes to apply a coating by means of a slurry. The application of a coating onto the sealing fins by means of a slurry has proven practicable and advantageous since an oxidation-resistant MCrAlY layer, where M is nickel and/or cobalt, is thereby applied and can be enriched with aluminum by means of an aluminizing process, so that there is a high aluminum content, which ensures good oxidation resistance, in the edge layer of the MCrAlY layer.

Hard material particles may be incorporated in the slurry, so that, besides the oxidation resistance, the applied MCrAlY can at the same time also fulfill the function of the wear protection layer.

As an alternative or in addition, a hard material layer may be deposited on the MCrAlY layer with aluminum enrichment existing in the edge region, in particular specifically by means of a spraying method such as thermal spraying, flame spraying, high-velocity flame spraying, electric arc spraying, cold gas spraying, detonation spraying, laser spraying and/or plasma spraying. in this way, it is possible to combine an advantageous configuration having an abrasive coating, which is applied by a spraying method, with a coating having good oxidation resistance.

The hard material layer may be formed from one or more constituents and may comprise oxides, carbides and/or nitrides. In particular, the hard material layer may be formed from aluminum oxide and/or titanium oxide.

The hard material particles, which may be incorporated in the MCrAlY layer, may likewise be formed by oxides, carbides, nitrides and/or mixtures thereof, and may in particular comprise boron nitride, cubic boron nitride, aluminum oxide, titanium oxide, titanium carbide, tungsten carbide, chromium carbide and zirconium oxide.

During the production of the MCrAlY layer, a slurry is initially provided which comprises particles of MCrAlY or particles for forming an MCrAlY layer, i.e. particles which comprise chromium, aluminum, yttrium and/or corresponding metals, such as nickel and/or cobalt, which are mixed in order to form a corresponding slurry suspension with a conventional binder, for example an inorganic binder or an organic binder, such as oil, in particular screen printing oil, and/or water.

The particle size of the particles may range from about 1 μm to 200 μm, in particular from about 5 μm to 120 μm. The slurry, which may comprise the corresponding hard material particles with a similar particle size, may be applied by spreading, immersion or spraying onto the sealing fins, before subsequently being dried at a temperature of from about 100° C. to 200° C., in particular from 120° C. to 150° C. for a period of from about one half to three hours, and in particular from about one to two hours, in air or in an inert gas atmosphere.

After the drying, a diffusion anneal of the slurry is carried out in order to form a solid MCrAlY layer with or without incorporated hard material particles, aluminizing being carried out at least partially at the same time. For example, the sealing fin with the applied slurry may initially be exposed to a diffusion annealing process in a vacuum for some time at a temperature of about 1000° C., before subsequently being treated further at a temperature of about 1100° C. for about four hours in an aluminizing atmosphere.

For the aluminizing, in particular gas-phase aluminizing, an aluminum donor, for example technically pure aluminum metal, and an activator, for example an activator containing halogen, in particular an activator containing chlorine or fluorine, are provided in a corresponding reaction chamber, so that the aluminum can he introduced via the gas phase into the edge region of the MCrAlY layer.

A corresponding hard material layer may then he deposited by a spraying process onto this MCrAlY layer having external aluminum enrichment.

### BRIEF DESCRIPTION OF THE DRAWINGS

The appended drawings show, purely schematically, in

FIG. 1 a partial longitudinal section along the rotation axis of a turbomachine,

FIG. 2 a partial section through a sealing fin according to a first embodiment of the invention, and in

FIG. 3 a partial section through a sealing fin according to a second embodiment of the invention.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

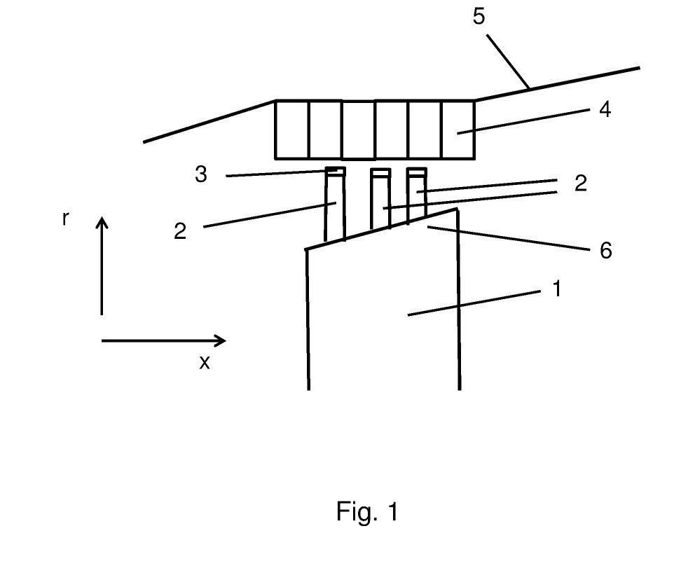

FIG. 1 shows a detail of a turbomachine in a longitudinal section along the rotation axis of the turbomachine. In the detail shown, a rotor blade 1 can be seen which extends both in the axial x direction along the rotation axis of the turbomachine and in the radial direction r, the axial direction x and the radial direction r being shown by corresponding arrows.

The rotor blade 1 is arranged next to a multiplicity of rotor blades (not shown) which are arranged around a rotation shaft, so that during operation of the turbomachine the rotor blade 1 rotates about a rotation axis parallel to the axial direction. The fluid of the turbomachine flows in the axial direction through a flow channel, which is bounded by a housing 5. In order to use as far as possible all the flowing fluid, the gap between the blade tip 6 and the housing 5 should be kept as small as possible. In order to compensate for the variations of the gap width due to different thermal conditions, pressure conditions and operating conditions, a plurality of sealing fins 2 are provided on the blade tip 6 of the blade 1, which protrude from the blade tip 6 in the radial direction at a distance from one another and extend in the circumferential direction along the blade tip 6 about the rotation axis of the turbomachine Arranged opposite the sealing fins 2, there is a running-in coating 4, for example in the form of a honeycomb structure, the running-in coating 4 being arranged on the housing 5. The sealing fins 2 are configured in such a way that they bed into the running-in coating 4 in order to form a so-called labyrinth seal. In order to avoid wear of the sealing fins 2 and increase the lifetime of the blade, or rotor blade, the sealing fins 2 comprise armoring 3 which improves the wear resistance during bedding of the sealing fins 2 into the running-in coating 4.

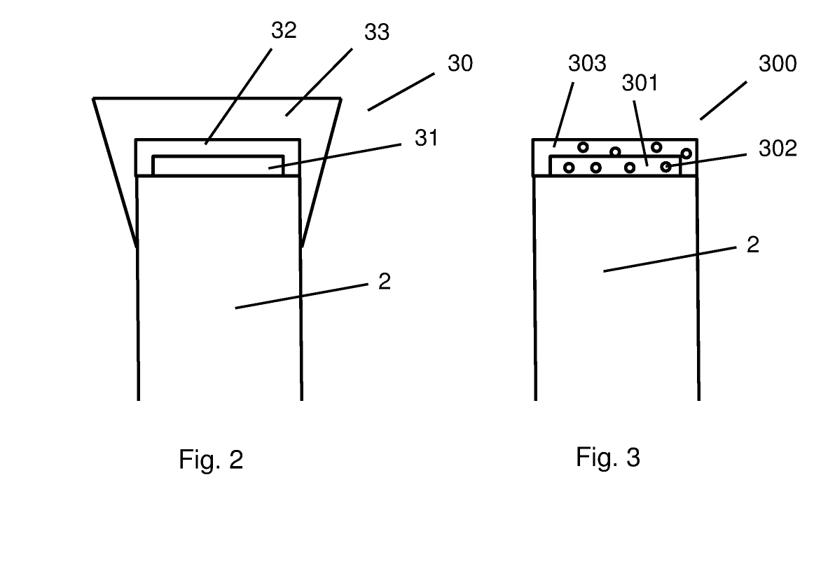

FIG. 2 shows, in a cross section through a sealing fin 2, one embodiment of armoring 30 such as is used for the armoring 3 of the rotor blade 1 of FIG. 1. The armoring 30 comprises an MCrAlY base layer 31, which has been deposited on the sealing fin 2 by the slurry process described above. in the edge region of the MCrAlY base layer, an aluminum-rich sublayer 32 is formed, which has been formed by an aluminizing process, for example gas-phase aluminizing with an activator containing halogen, for example an activator containing fluorine or chlorine. Preferably, the aluminum-rich sublayer 32 was generated simultaneously with the diffusion anneal of the slurry for forming the MCrAlY layer 31, during which the slurry comprising MCrAlY particles or corresponding particles for forming MCrAlY layers, which is applied in the liquid or paste form, was exposed after drying to a suitable heat treatment in order to form the MCrAlY layer by diffusion processes. During the combined diffusion anneal treatment with aluminizing to form the MCrAlY layer enriched with aluminum in the edge region, an aluminum donor and one or more activator substances for the gas-phase aluminizing are provided in a correspondingly configured treatment chamber, so that aluminum can be enriched in a sublayer 32 of the edge region of the MCrAlY layer 31. In order to avoid aluminizing of the sealing fin 2, the latter may be covered during the diffusion anneal and the aluminizing

A hard material layer, for example an oxide-ceramic layer comprising titanium oxide and aluminum oxide is applied by means of a spraying method, for example thermal spraying or plasma spraying, onto the MCrAlY base layer 31 formed in this way with the aluminum-rich sublayer 32. The sprayed hard material layer 33 may for example he applied, by two coating sources arranged correspondingly at an angle, in such a way that the hard material layer 33 is formed axially increasingly in the radial direction r, so that a wedge-shaped hard material layer 33 that increases in its width in the radial direction is formed.

FIG. 3 shows a second embodiment of armoring 300 on a sealing fin 2, which was likewise formed by means of the slurry process described above. The armoring 300 comprises an MCrAlY base layer 301, which differs from the MCrAlY base layer 31 of the embodiment of FIG. 2 in that hard material particles 302, for example particles of boron nitride, tungsten carbide, aluminum oxide, titanium oxide or the like, are incorporated in the MCrAlY base layer 301.

This is achieved by virtue of the fact that hard material particles which are incorporated in the thus formed MCrAlY base layer 301 after drying of the slurry and the diffusion annealing for layer formation are additionally incorporated in the liquid or pasty slurry comprising MCrAlY particles or particles which can form an MCrAlY layer.

As during the production of the MCrAlY base layer 31 of the exemplary embodiment of FIG. 2, the diffusion anneal for producing the MCrAlY base layer 301 of the exemplary embodiment of FIG. 3 may be associated simultaneously with an aluminizing process by an aluminum donor material and corresponding activators, for example activators containing halogen, being provided in a treatment chamber at least during a part of the diffusion anneal, in order to cause aluminizing of the edge layer of the MCrAlY base layer. Correspondingly, the armoring 300 comprises an aluminum-rich sublayer 303 in the edge region of the MCrAlY base layer 301, which increases the oxidation resistance of the sealing fin 2 comprising the armoring 300.

Although the present invention has been described in detail with the aid of the exemplary embodiments, it is clear to the person skilled in the art that the invention is not restricted to these exemplary embodiments, but rather that variants are possible in that individual features may be omitted or other combinations of features may be implemented, so long as the protective scope of the appended claims is not departed from. The present disclosure also includes all combinations of the individual features proposed.

### LIST OF REFERENCE NUMBERS

1 blade
2 sealing fin
3 armoring
4 running-in coating
5 housing
6 blade tip
30 armoring
31 MCrAlY base layer
32 aluminum-rich sublayer
33 hard material layer
300 armoring
301 MCrAlY base layer
302 hard material particles
303 aluminum-rich sublayer

What is claimed is:

1. A method for coating a sealing fin on a component of a turbomachine with armoring, in which method a blade having at least one sealing fin is provided and wherein the method comprises applying onto the sealing fin a slurry which comprises particles of MCrAlY or particles for forming an MCrAlY layer, where M represents nickel and/or cobalt, and aluminizing the sealing fin having the slurry applied thereon.

2. The method of claim 1, wherein a sealing fin on a blade tip of a blade of a turbomachine is coated.

3. The method of claim 1, wherein the slurry comprises hard material particles.

4. The method of claim 1, wherein the method further comprises depositing a hard material layer on the coating following the aluminizing.

5. The method as claimed in claim 4, wherein depositing the hard material layer is carried out by one or more of spraying, thermal spraying, flame spraying, high-velocity flame spraying, electric arc spraying, cold gas spraying, detonation spraying, laser spraying, and plasma spraying.

6. The method of claim 4, wherein the hard material layer is formed from aluminum oxide and/or titanium oxide.

7. The method of claim 5, wherein the hard material layer is formed from aluminum oxide and/or titanium oxide.

8. The method of claim 3, wherein the hard material particles comprise at least one substance selected from oxides, carbides, nitrides,

9. The method of claim 3, wherein the hard material particles comprise at least one of boron nitride, cubic boron nitride, aluminum oxide, titanium oxide, titanium carbide, tungsten carbide, chromium carbide, zirconium oxide.

10. The method of claim 1, wherein the method further comprises drying the slurry before aluminizing, and/or wherein aluminizing is carried out with an activator which contains halogen.

11. The method of claim 1, wherein aluminizing is carried out with an activator which contains halogen.

12. The method of claim 1, wherein the particles of MCrAlY or particles for forming an MCrAlY layer have a particle size of from about 1 μm to 200 μm.

13. The method of claim 1, wherein the particles of MCrAlY or particles for forming an MCrAlY layer have a particle size of from about 5 μm to 120 μm.

14. The method of claim 10, wherein the slurry is dried at a temperature of from about 100° C. to 200° C.

15. The method of claim 10, wherein the slurry is dried at a temperature of from about 120° C. to 150° C.

16. A component of a turbomachine, which component comprises at least one sealing fin on a blade tip of a blade, wherein the at least one sealing fin comprises armoring which comprises an MCrAlY layer, where M represents nickel and/or cobalt, a hard material layer being present on the MCrAlY layer and an Al-rich layer being present in an interface region between the MCrAlY layer and the hard material layer.

17. The component of claim 16, wherein the blade comprises a plurality of sealing fins on the at least one blade tip.

18. The component of claim 16, wherein the hard material layer is formed from aluminum oxide and/or titanium oxide.
